(19) United States
(12) Patent Application Publication
(10) Pub. No.: US 2010/0162871 A1
(43) Pub. Date: Jul. 1, 2010

(54) Slitting machine having variable adjustment of the blade cutting points

(75) Inventor: Rudolf Supe-Dienes, Overath (DE)

Correspondence Address: ROBERT W. BECKER & ASSOCIATES, 707 HIGHWAY 333, SUITE B, TIJERAS, NM, 87059-7507, US

(73) Assignee: Dienes Corporation, Spencer, MA (US)

(21) Appl. No.: 12/640,341

(22) Filed: Dec. 17, 2009

(30) Foreign Application Priority Data
Dec. 17, 2008 (DE) 20 2008 016 612.8

(51) Int. Cl. B31B 1/25

(52) U.S. Cl. 83/884

(57) ABSTRACT

A slitting machine with an upper blade arrangement having a plurality of blade holders supported on a cross beam via associated position-securing mechanisms. Each blade holder is provided with a lowering device and a cutter head for a circular blade supported thereon, each cutter head being carried by the lowering device. Each circular blade is adapted to overlap a blade edge of a lower blade to form a cutting point disposed on the entry side of the material that is to be cut. A device is provided for adjusting a horizontally measured distance of the cutting point of the circular blade from the cross beam.

The present invention relates to a slitting machine having an upper blade arrangement and a lower blade arrangement, wherein the upper blade arrangement has a plurality of blade holders that are supported on a cross beam via associated position-securing mechanisms, with each blade holder being provided with a respective lowering device and a cutter head for a circular blade supported thereon, wherein the cutter head is carried by the lowering device and wherein each circular blade, by overlap with the blade edge of an associated lower blade, forms a cutting point that is disposed on the entry side of the material that is to be cut.

A slitting machine having the aforementioned features is described, for example, in DE 20 2007 008 730 U1. With such slitting machines, it is known to set or control the lowering movement for the circular blade that is supported on the cutter head of each blade holder disposed on the slitting machine in such a way that a desired overlap of the upper blade carried by the cutter head with the associated lower blade of the slitting machine results. This overlap of two circular blade edges forms a secant with two respective engagement points disposed across from one another on the blade edges. The engagement point that faces the feed of the material that is to be cut to the blade arrangement forms the cutting point of the respective blade arrangement, because at this cutting point upper blade and lower blade together come into engagement with the material that is to be cut.

To the extent that for example when using a new blade having a different diameter of its circumferential blade edge, or to however due to manufacturing tolerances of the blade holders and their individual parts, also an already different position or alteration of the position of the cutting points of individual blade holders results upon engagement of the upper blade and the lower blade that are associated with one another, there are applications where the different position of the cutting points of individual blade holders within a row of blade holders disposed next to one another on the cross beam of a slitting machine has a negative impact on the cutting quality relative to the material that is guided to the slitting machine because over its length the material is handled by the blade arrangements at different points in time.

It is therefore an object of the present invention, with a slitting machine having the aforementioned general features, to ensure a defined or constant position of the cutting points of the individual blade arrangements.

The realization of this object, including advantageous embodiments and further developments of the invention, can be seen from the content of the claims that follow this description.

The basic concept of the invention is that the horizontally measured distance of the cutting point of the circular blade from the cross beam is adjustable by means of a device. The present invention has the advantage that by the reference of the position of the cutting point of an individual blade holder to the cross beam, the position of which is securely fixed for a slitting machine, and by the provision of a device for the adjustment of the distance existing between the respective cutting point and the cross beam, it is possible for all blade holders secured to a cross beam to be able to set the cutting point such that over the length of the cross beam, or the width of the material that is to be cut, there results such a position of the cutting points that the length of material is simultaneously handled and cut by all of the upper blades and associated lower blades.

Pursuant to a first embodiment of the invention, the position-securing mechanism for the support of the associated blade holder on the cross beam includes a mechanism for the adjustment of the distance between the blade holder and the cross beam.

The device can in particular comprise two side pieces that laterally span the blade holder and have slots disposed therein for receiving securement means for connecting the blade holder with the side pieces, so that the blade holder is displaceable on the side pieces that hold it and hence can have its distance relative to the cross beam altered.

Alternatively, an angle plate positioned between the position-securing mechanism and the blade holder can be provided for the establishment of a pivoting of the blade holder relative to the cross beam, so that by the introduction of the angle plate, a respectively different angular position of the blade holder relative to the cross beam can be established.

Pursuant to a further embodiment, the blade holder can be mounted on the position-securing mechanism so as to be pivotable about a pivot axis; also in this way the horizontally measured distance of the cutting point of the circular blade from the cross beam can be set.

Pursuant to another embodiment of the invention, a device for the adjustment of the distance between the lowering device and the cutter head can be provided between the lowering device and the cutter head that is held thereon, whereby by the adjustment of the distance between the lowering device and the cutter head, due to the fixation of the blade holder with the lowering device on the cross beam, also the distance between the cutting point of the circular blade supported on the cutter head and the cross beam is adjustable.

For this purpose, pursuant to one embodiment of the invention the cutter head can be displaceable on the lowering device by means of a linear guide that is oriented relative to the cross beam, whereby the linear guide can be a dovetailed guide.

Pursuant to a further embodiment of the invention, the circular blade, which is held on the cutter head and is disposed at an angle relative to the cross beam, can, by means of a slot that is formed on it and that extends over an associated pin of the cutter head, be displaceable relative to the cutter head for the adjustment of the distance between the circular blade and the cross beam. To the extent that the circular blade is adjustable on the cutter head, there thereby also results an alteration of the position of the blade edges and hence the cutting point relative to the cross beam.

To the extent that in a customary manner appropriate blade holders having a depth-setting device for the lowering movement of the cutter head that carries the circular blade are provided, in order to be able to take into consideration an alteration of the diameter ratio for the circular blades being used with respect to a constant overlap with the lower blade, such a depth-setting device can be eliminated and can be replaced by a fixedly prescribed lowering travel of the lowering device if, pursuant to one exemplary embodiment of the invention, the longitudinal axis of the slot that enables an adjustment of the distance of the cutting point of the circular blade from the cross beam is oriented at an angle, relative to, the lowering direction of the lowering device, that brings about the adjustment of the distance between the circular blade and the cross beam. If in such a case, for the adaptation of its overlap with the lower blade, the position of the circular blade relative to the cutter head is shifted, then due to the orientation of the slot, which deviates from the lowering direction, there automatically also results an adjustment of the distance of the circular blade to the cross beam, with an adaptation of the cutting point to the altered diameter ratio.

Pursuant to another embodiment of the invention, the cutter head can be mounted on the lowering device so as to be pivotable about a pivot axis, so that also in so doing the distance of the cutting point of the circular blade relative to the cross beam can be adjusted.

Pursuant to yet another embodiment of the invention, the lowering device for the cutter head can be embodied with an inclined guide that extends at an angle relative to the cross beam in such a way that as a function of the lowering depth of the cutter head, the cutter head assumes a different distance relative to the cross beam. The inclined guide is preferably embodied as a curved guide that describes a curved path.

Finally, pursuant to the present invention, the position-securing mechanism, which is to be fixed in position on the cross beam, can be oriented in an angular position relative to the cross beam in that, for example, an abutment surface of the position-securing mechanism on the cross beam can be altered by means of a set screw, so that the desired angular position of the position-securing mechanism relative to the cross beam results.

The aforementioned embodiments can be realized alternatively relative to one another, but also in various combinations with one another, since in so doing the range of adjustment of the given distance between the cutting point and the cross beam is increased.

To the extent that with the adjustment of the cutting point there is connected an active linear or pivot movement of one component relative to another component, pursuant to another embodiment of the invention the device for the adjustment of the cutting point is coupled with a drive, whereby an automatic adjustment of the cutting point via the drive can be provided. Such a drive can have any desired configuration, for example can be configured as a pneumatic drive or a drive that operates in an electromotor manner, for example incorporating a spindle drive.

Exemplary embodiments of the invention, which will be described subsequently, are shown in the drawings, in which:

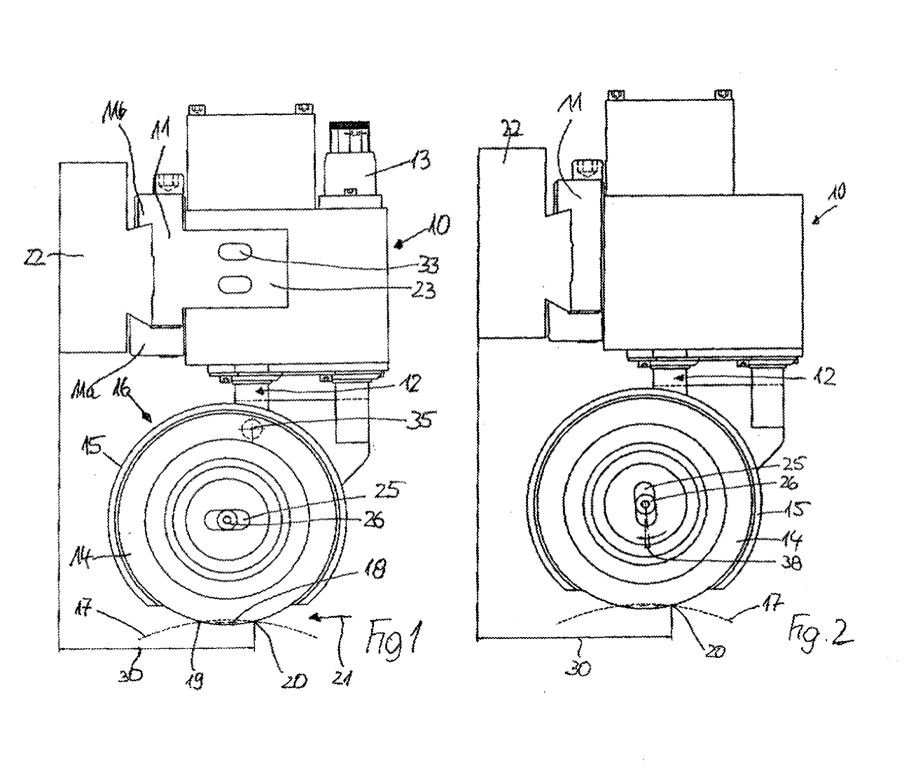

FIG. 1 is a side view of the cross beam of a slitting machine having a blade arrangement, composed of upper blade and lower blade, disposed thereon, and includes a plurality of devices for the adjustment of the blade cutting point,

FIG. 2 shows the subject matter of FIG. 1 in an embodiment that is altered with regard to the fixing in position of the circular blade on the cutter head,

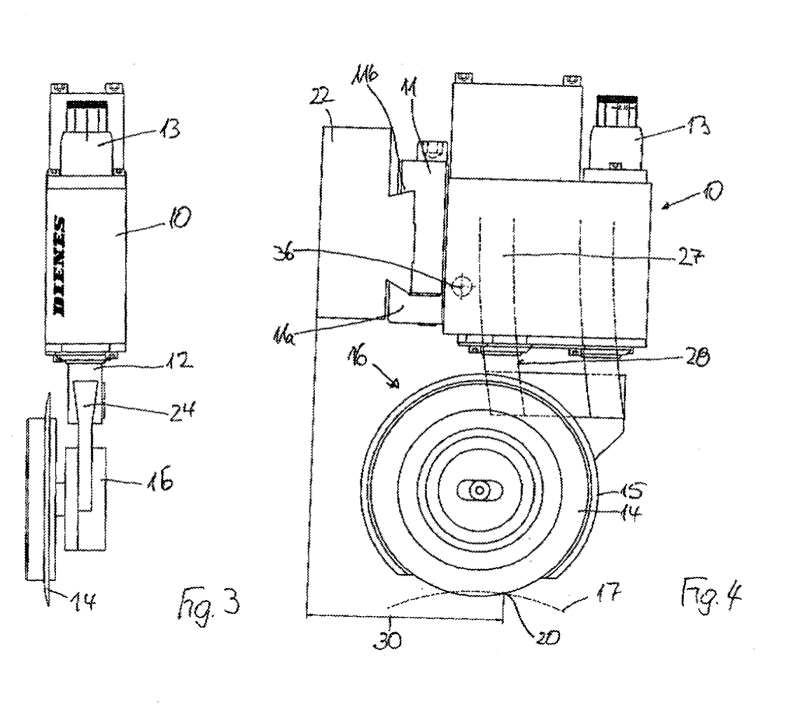

FIG. 3: is a view of the subject matter of FIG. 1 with a further adjustment device, and

FIG. 4: shows a modified embodiment of the subject matter of FIG. 1, again with a different adjustment device.

The blade holder 10, which is initially visible in FIG. 1, is placed upon the cross beam 22 of a slitting machine, which is not illustrated further, by means of a clamping device 11, which serves as a position-securing device; the blade holder is displaceable in a suitable manner along the cross beam 22, and finally can be fixed in position on the cross beam in a prescribed cutting position by means of the clamping device 11. The blade holder 10 is provided with a lowering device 12, which is not illustrated in detail, for the blade or cutter head 16, which is carried thereby, and also has a depth-setting device 13 for setting the lowering travel of the lowering device 12.

As can further be seen in FIG. 1, disposed on the cutter head 16 is a circular blade 14 as an upper blade, which is surrounded by a hand guard 15. A lower blade 17 is associated with the circular blade 14, and can similarly be embodied as a circular blade carried by a blade holder, or can also be formed by a blade edge of a lower blade shaft or of a cutter sleeve. For the cutting operation, an overlap is established between the circular blade 14 and the lower blade 17 that leads to the formation of a secant 18 between outer engagement points 19 of the two blades with one another. Assuming the arrow 21 to be the direction of material feed of the material that is to be cut to the blade arrangement, the engagement point that faces the material feed forms the cutting point 20 of the blade arrangement. To the extent that the cross beam 22 of the slitting machine represents a component that can be fixed in its position, and is thus suitable as a reference line for the fixation of the cutting point 20, the invention relates to the setting or adjustment of the spacing or distance 30 between the cutting point 20 and the cross beam 22.

In connection with a first embodiment of the invention, and in particular with the embodiment seen in FIG. 1, an appropriately embodied adjustment device is disposed between the blade holder 10 and its clamping device 11 that is to be fixed in position on the cross beam 22; by means of the adjustment device the blade holder 10 can be adjusted relative to the cross beam 22. In the illustrated embodiment, this adjustment device is comprised of two side pieces 23, which laterally hold the blade holder 10 between them and which are provided with slots 33 for receiving non-illustrated securement means for securing the blade holder 10 to the side pieces 22, so that the blade holder 10 can be fixed in position in various positions relative to the side pieces 23 of the clamping device 11. It is prudent that with the adjustment of the spacing between the blade holder 10 and a cross beam 22, at the same time also the distance 30 between the cutting point 20 and the cross beam 22 can be changed and hence adjusted.

Pursuant to an alternative also illustrated in FIG. 1, the cutter head 16 on the lowering device 12 can also be pivotable about the pivot axis 35, with this also providing the possibility of being able to appropriately adjust the distance 30 between the cutting point 20 and the cross beam 22.

A further embodiment that can be seen from FIG. 1 for the adjustment of the distance 30 is obtained by displaceably disposing the circular blade 14 on the cutter head 16 laterally relative to the cross beam 22, for example in that a slot 25 formed in the circular blade 14 extends over a pin 26 disposed on the cutter head 16, so that different positions of the circular blade 14 on the cutter head 16 can be established.

This last-mentioned embodiment is modified pursuant to the alternative illustrated in FIG. 2 in that the slot 25 has such an orientation that at the same time a depth setting device that would be separately provided on the blade holder 10 can be eliminated. In this regard, in contrast to the embodiment illustrated in FIG. 1, with the embodiment illustrated in FIG. 2 no depth-setting device is illustrated. The object of the depth setting is the setting of the desired overlap between the circular blade and the lower blade when the diameter of the circular blade is altered, for example when using a new circular blade or when carrying out a resharpening. With the embodiment illustrated in FIG. 1, this setting of the overlap is effected via the change of the depth setting. With the embodiment illustrated in FIG. 2, the overlap can be undertaken by shifting the circular blade 14 in the slot 25 relative to the cutter head 16. However, since the longitudinal axis of the slot 25 does not coincide with the lowering direction of the lowering device 12, but rather is offset at an angle 38 thereto, when the circular blade 14 is shifted or displaced relative to the cutter head 16, at the same time also the position of the cutting point 20 in its distance 30 from the cross beam 22 is altered.

As can be seen from FIG. 3, an appropriate adjustment device can also be disposed between the lowering device 12 or the to pertaining lowering piston rod 27, and the cutter head 16 carried thereby, so that again the cutter head 16 is adjustable in the plane of the circular blade relative to the blade holder 10 via the lowering device 12. With the embodiment illustrated in FIG. 3, the cutter head 16 is held on the lowering device 12 by means of a linear guide 24, which is embodied as a dovetailed guide, in such a way that the cutter head 16 is displaceable in the direction of the cross beam 22. Also with this measure the distance 30 between the cutting point 20 and the cross beam 22 can be adjusted or set.

FIG. 4 shows a further possibility for adjusting the distance in that for example the end of the lowering piston rod 27, or with a dual guidance each of the two guide rods, is provided with a curved guide 28 that extends in the plane of the circular blade 14, so that again the position of the circular blade 14 relative to the cross beam 22 can be altered. Instead of the curved guidance illustrated in FIG. 4, a simple inclined guidance relative to the two guide rods is also adequate.

FIG. 4 furthermore illustrates the possibility of supporting the blade holder 10 on the clamping device 11 such that it is pivotable about a pivot axis 36, thus also providing the possibility for adjusting the distance 30 between the cutting point 20 and the cross beam 22.

A further embodiment can be directed to additionally disposing at least one angle plate 37 between the clamping device 11 and the blade holder 10 that is clamped between the clamping device 11 and the blade holder 10 and via which a respectively different angular position of the blade holder 10 relative to the clamping device 11 can be set, so that also in so doing the distance 30 between the cutting point 20 and the cross beam 22 can be altered and thus adjusted.

Although not illustrated in the drawing, there is finally also the possibility to make it possible to alter the position of the blade holder 11, including the clamping device, relative to the cross beam 22 to the extent that the clamping device 11 in a customary manner is provided with a movable lower clamping jaw 11a that can be fixed in position on the cross beam 22. To the extent that, for example, the position of the upper, fixed clamping surface 11b can be altered by means of a screw provided there relative to the cross beam 22, again different angular positions of the blade holder 10 with the clamping device 11 can be set on the cross beam 22, with these angular positions leading to an alteration of the distance 30 between the cutting point 20 and the cross beam 22.

It is to be understood that a suitable drive for adjusting the cutting point 20 can be provided and can be integrated into the slitting machine or the blade arrangement.

The features of the subject matter of these documents disclosed in the preceding description, the claims and the drawings can be important individually as well as in any desired combination with one another for realizing the various embodiments of the invention.

1-15. (canceled)

16. A slitting machine, comprising:
an upper blade arrangement having a plurality of blade holders (10) supported on a cross beam (22) via associated position-securing mechanisms (11), wherein each of said blade holders (10),is provided with a lowering device (12) and a cutter head (16) for a circular blade (14) supported thereon, and wherein said cutter head (16) is carried by said lowering device;
a lower blade arrangement that includes lower blades (17), wherein each of said circular blades (14) is adapted to overlap a blade edge of one of said lower blades (17) to form a cutting point (20) disposed on an entry side where material that is to be cut is adapted to enter; and
a device for adjusting a horizontally measured distance (30) of said cutting point (20) of said circular blade (14) from said cross beam (22).

17. A slitting machine according to claim 16, wherein said position-securing mechanism (11) for the support of an associated one of said blade holders (10) on said cross beam (22) includes a mechanism (23) for the adjustment of the distance (30) between said blade holder (10) and said cross beam (22).

18. A slitting machine according to claim 17, wherein said mechanism is comprised of two side pieces (23) that laterally span said blade holder (10) and are provided with slots (33) disposed therein for receiving securement means for connecting said blade holder (10) with said side pieces (23).

19. A slitting machine according to claim 17, wherein said mechanism includes at least one angle plate (37) positioned between said position-securing mechanism (11) and said blade holder (10) for establishing a pivoting of said blade holder (10) relative to said cross beam (22).

20. A slitting machine according to claim 16, wherein said blade holder (10) is mounted on said position-securing mechanism (11) so as to be pivotable about a pivot axis (35).

21. A slitting machine according to claim 16, wherein said cutter head (16) is supported on said lowering device (12) and wherein a mechanism (24) for adjustment of the distance (30) between said lowering device (12) and said cutter head (16) is provided between said lowering device (12) and said cutter head (16).

22. A slitting machine according to claim 21, wherein said mechanism is comprised of a linear guide (24) oriented relative to the cross beam (22).

23. A slitting machine according to claim 22, wherein said linear guide is a dovetailed guide.

24. A slitting machine according to claim 16, wherein said circular blade (14) is supported on said cutter head (16) and has a blade plane that is disposed at an angle relative to the cross beam (22), further wherein said circular blade (14) is provided with a horizontally oriented slot (25) that extends over a pin (26) of said cutter head (16), and wherein said circular blade (14) is displaceable via said slot (25) relative to the cutter head (16) for adjustment of the distance (30) between said circular blade (14) and said cross beam (22).

25. A slitting machine according to claim 24, wherein a longitudinal axis of said slot (25) is oriented at an angle (38) relative to a direction of lowering of said lowering device (12), and wherein said angle (38) brings about adjustment of the distance (30) between said circular blade (14) and said cross beam (22).

26. A slitting machine according to claim 16, wherein said cutter head (16) is mounted on said lowering device (12) so as to be pivotable about a pivot axis (36).

27. A slitting machine according to claim 16, wherein said lowering device (12) for the cutter head (16) is configured with an inclined guide that extends at an angle relative to said cross beam (22) such that as a function of a lowering depth of said cutter head (16), said cutter head (16) assumes a different distance (30) relative to said cross beam (22).

28. A slitting machine according to claim 27, wherein said inclined guide is embodied as a curved guide (28) that describes a curved path.

29. A slitting machine according to claim 16, wherein said position-securing mechanism (11) is adapted to be fixed in position on said cross beam (22), and wherein said position-securing mechanism (11) can be oriented in an angular position relative to said cross beam (12).

30. A slitting machine according to claim 16, wherein said device for adjusting the distance (30) of said cutting point (20) is adapted to be coupled to a drive.
